(19) United States
(12) Patent Application Publication
(10) Pub. No.: US 2016/0058059 A1
(43) Pub. Date: Mar. 3, 2016

(54) ENRICHED FISH FILLETS

(71) Applicant: Oregon State University, Corvallis, OR (US)

(72) Inventors: Jae W. Park, Warrenton, OR (US); Angela L. Hunt, Newport, OR (US); Tao Yin, Corvallis, OR (US)

(73) Assignee: Oregon State University, Corvallis, OR (US)

(21) Appl. No.: 14/838,176

(22) Filed: Aug. 27, 2015

Related U.S. Application Data
(60) Provisional application No. 62/043,317, filed on Aug. 28, 2014.

(51) Int. Cl. A23L 1/325

(52) U.S. Cl. CPC A23L 1/325; A23L 1/3255; A23V 2002/00

(57) ABSTRACT

Fish bone can be ground into nano-scale particles and then mixed with surimi to form a marinade that can be injected into boneless fish fillets or otherwise added to boneless fish fillets to increase the highly bioavailable dietary calcium content, reduce drip loss and cook loss, improve yield, demonstrate improved texture after frozen storage, and/or provide other benefits. The reintroduction of fish bone back into boneless fish fillets can utilize a conventionally discarded natural resource and reduce waste.

### CROSS-REFERENCE TO RELATED APPLICATIONS

This application claims the benefit of U.S. Provisional Application No. 62/043,317 filed Aug. 28, 2014, which is incorporated by reference herein in its entirety.

### SUMMARY

In an exemplary method, fish bone can be ground to nano-scale and mixed with surimi in a slurry for injection into fish fillets. The slurry can be utilized to increase dietary calcium of fish fillets and improve texture and moisture retention during frozen storage of fish fillets. Nano-scale fish bone, which can be obtained from fish processing discards or other sources, can be prepared, mixed with surimi slurry and/or other ingredients to form a marinade, and injected into fish fillets prepared from the same or different fish species as the fish bone to increase the highly bioavailable dietary calcium and maintain the texture of fillets during frozen storage.

### BRIEF DESCRIPTION OF THE DRAWINGS

FIG. 1 is a diagram of an exemplary system for preparing nano fish bone emulsion.

FIG. 2 is a perspective view of an exemplary device for poking fish and/or injecting fish fillets with a marinade.

FIG. 3 shows the device if FIG. 2 poked into a fish fillet for injection of a marinade.

FIG. 4 is a graph showing marinade retention rates for various combinations of number of poking instances and duration of soaking in a marinade.

FIG. 5 is a graph showing drip loss percentage for uncooked salmon fillets and cook loss percentage for cooked salmon fillets having different levels of marinade content and having been frozen for 0, 8, or 16 weeks.

FIG. 6 is a graph showing how overall fish fillet texture values (cutting force and cutting distance) vary based on marinade content and duration of frozen storage time.

FIG. 7 includes tables illustrating sensory evaluation data for fish fillets having differing marinade content and frozen storage time.

### DETAILED DESCRIPTION

In 2010, commercial fisheries and aquaculture processed approximately 148 million tons of fish globally. This resulted in over 20 million tons of discarded processing leftovers, including trimming, fins, bones, head, skin, and viscera, much of which is converted to fish meal. Fish bones are the main solid by-product of the fillet and surimi processing industries and can account for 10-15% of fish weight.

Calcium compounds from fish bone have high bioavailability. However, the bioavailability of fish bone depends on the size of bone particles: generally the smaller the particle is, the higher the bioavailability is. Nano-scaled bone can have much better bioavailability than larger bone particles.

When fish are processed into fillets or surimi, the calcium contributed from bone is lost. Injecting a slurry of nano-scale fish bone and surimi (and optionally other ingredients) into fillets can add back the lost dietary calcium and significantly reduce the waste stream. In addition, injected marinades carrying nano-scale bone can increase moisture retention during frozen storage, resulting in superior eating quality that is more similar to that of a fresh fish fillet.

Fish bone can be recovered and ground into nano-scale particles. This recovered fish bone can then be mixed with a surimi slurry to form a marinade that can be injected into boneless fillets or otherwise added to boneless fillets to increase the dietary calcium content as well as enhance fillet texture during frozen. The reintroduction of fish bone back into a fish fillet product can utilize this currently discarded resource of dietary calcium. Adding a marinade including surimi and nano fish bone can also increase the production yield of fish fillets when they are later cooked due to the reductions in drip loss and cook loss.

Injecting fillets with a marinade comprising fish bone and surimi can in some cases include an additional processing step. In some methods, nano-fish bone and surimi slurry at their optimum or predetermined desirable levels can be homogeneously mixed before injection. Exemplary advantages imparted by such methods include increasing calcium content and improving texture/moisture retention.

Nano-scale fish bone can also be used as an ingredient to increase the bioavailable dietary calcium of other seafood products, such as halibut steaks, tuna steaks, salmon steaks or burgers, fish sticks, or other products where ingredients are mixed and formed into shapes for consumption.

### EXAMPLE 1

1) Preparation of Nano Fish Bone (NFB)

In exemplary methods, fish bone (fresh or after thawing if frozen) is cut into small pieces, such as about 5 cm long. After washing the cut bone using tap water, these pieces are submerged in water and heated at 121° C. for 1 h using a pressure cooker or similar device (at approximately 0.2 MPa). After pressure cooking, flesh and/or collagen freely dissociate from the bone and can be removed along with floating fat and liquid. Wet bone can then be coarsely minced, such as by using a meat grinder. The minced bone can then be mixed with ice water (approximately 1:0.3 ratio) and ground to a paste, such as by using a mill at 2,000 rpm and 3,000 rpm consecutively for about 3 sec each. Subsequently, the paste can be spread out in approximately 0.5 mm thickness and dried, such as at 105° C. for 6 h in an oven. Dried bone solid can then be subjected to coarse milling using a pulverizer and screened through a sieve (105 μm). The average particle size (D50) of the resultant fish bone powder can be 20-25 μm. This fish bone powder can be referred to as micro fish bone (MFB). MFB can be mixed with water to form a suspension and the total solid content of the suspension can be adjusted to about 5 g/100 g.

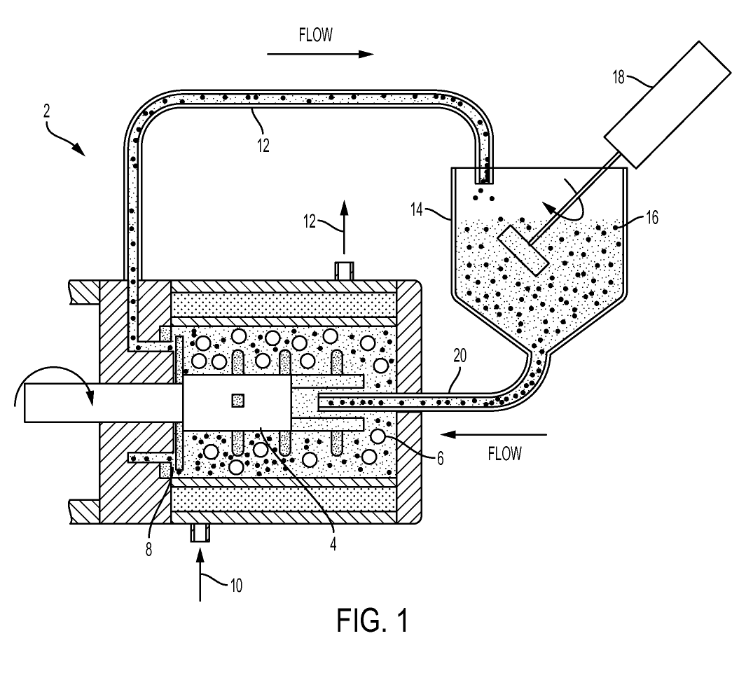

As shown in FIG. 1, the MFB suspension can be transferred into a mixing chamber 2 of a high-energy wet media mill through a hopper 14 and milled using milling beads 6 (e.g., YSTZ (yttria-stabilised tetragonal zirconia) milling beads). The suspension is circulated between the milling chamber 2 and the hopper 14 via conduits 12 and 20. The suspension in the hopper 14 can be mixed continuously using a stirrer 18, such as at a speed of about 600 rpm. The outer wall of the milling chamber 2 can include a cold water jacket (approximately 10-15° C.) having a cooling inlet 10 and a cooling outlet 12. The mill can include an agitator or separation system 4 that includes separating rings made from tungsten carbide with a slot width of 0.15 mm, for example. The chamber 2 can include a separation gap 8 at its outlet that is sized to allow the suspension and resultant nano-fish bone (NFB) emulsion to circulate but prevent the milling beads 6 from passing out of the chamber. In process optimization, important parameters can include milling bead 6 diameter, agitation speed, and filling ratio of the beads. The resulting NFB emulsion can comprise nanoparticles having an average size of 1 nanometer (nm) to 1 micrometer (μm), such as from 1 nm to 100 nm.

2) Preparation of Surimi

In exemplary methods of preparing surimi, fish fillets are ground first using a meat deboner with 3-5 mm perforations where fish skin and bone are removed. Washing can be done using 1:3 (meat:cold water) by stirring for 5-15 min and floating fat and water soluble pigments (e.g., heme proteins) are removed using screens (1-2 mm). This process can be repeated twice or more. The remaining wet meat is subjected to a screw press to remove free water. Moisture content can range from 82-86%. The fish meat after screwpressing is then mixed thoroughly with cryoprotectants (sugar 4%, sorbitol 5%, and 0.3% sodium polyphosphate) before freezing the surimi at −25° C. for 2-3 hrs. Surimi processing steps can be performed at a temperature of 0-5° C. Commercial surimi can alternatively be used to replace this reprocess in some methods.

3) Preparation of Marinade

In exemplary methods of preparing a marinade (also referred to herein as a mixture), frozen surimi is thawed to obtain a core temperature near −5° C. and cut into pieces (e.g., 1-2 inch cubes). Surimi alone can be first chopped with 5% NaCl (salt), such as for 6-10 minutes, to maximally extract myofibrillar protein. The salted surimi paste can then be mixed using 1 part of surimi paste, 4-5 parts of NFB emulsion, and 1-2 parts of water (if necessary) to form a marinade or mixture that is added (e.g., injected into) to fish fillets. The NFB can be derived from the same fish as the surimi, or from different fish. Marinades can also be made with different ratios of surimi paste, NFB emulsions, and water. Water may not be added in some formulations. Other liquids can also be used instead of water. The marinade or mixture can comprise at least 20% fish bone, at least 50% fish bone, at least 80% fish bone, and/or at least 90% fish bone. The marinade or mixture can comprise 10% or less surimi, at least 10% surimi, at least 20% surimi, at least 50% surimi, and/or at least 80% surimi.

4) Application of Marinade to Fish Fillets

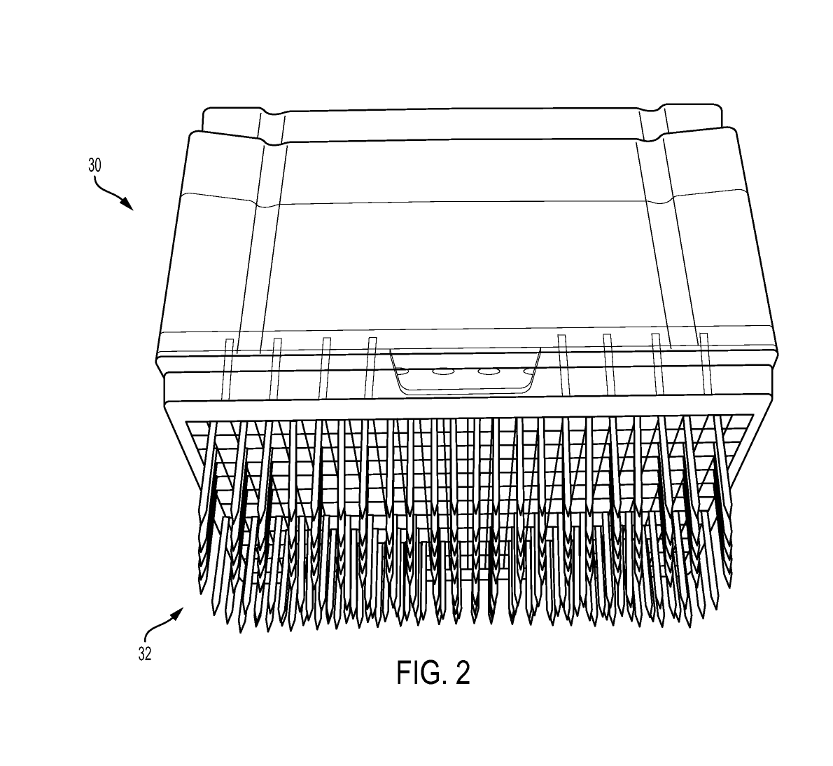

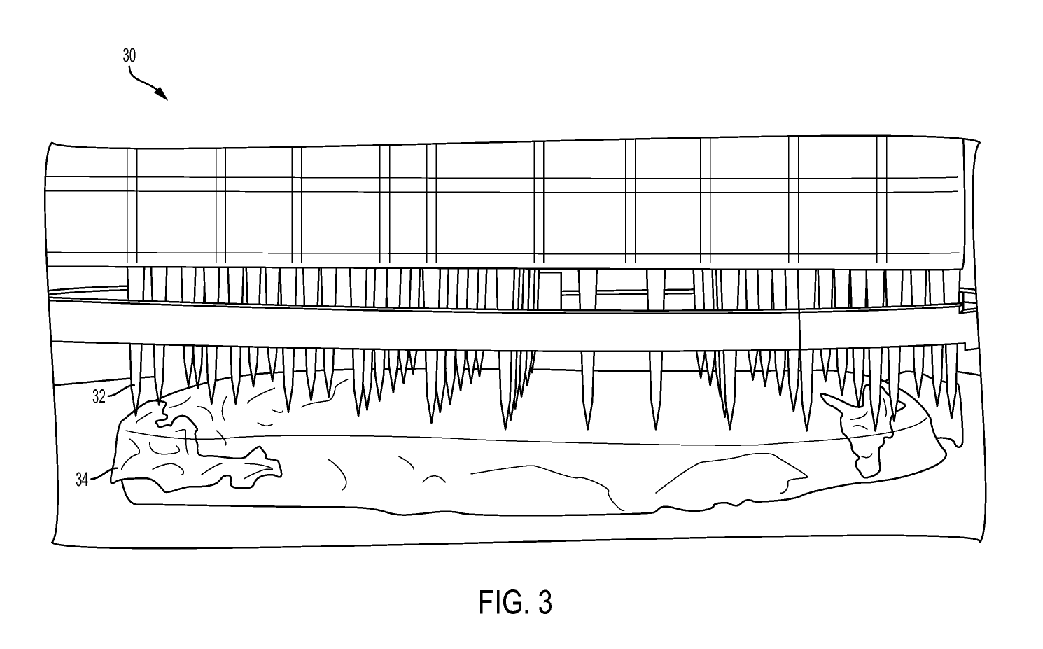

In exemplary methods of applying marinade to fish fillets, the marinade is prepared using surimi paste, NFB emulsion, and/or water (as described above) before applying the marinade into fish fillets. Application can be done by injection, soaking, and/or other methods. Injections can be done mechanically using an injector device and/or a poking device followed by soaking. An exemplary fillet poking device 30 having a plurality of pokers 32 is shown in FIG. 2. In FIG. 3, the pokers 32 are inserted into a fish fillet 34. Desirably, the pokers 32 penetrate deep into the fish fillet but do not pass all the way through the fish fillet. For example, the pokers can penetrate to a depth of 50-90% of the thickness of the fillet. In some embodiments, poking is performed on only one side of the fillet, while in other embodiments, poking can be performed on both sides of the fillet. The resulting perforations, or cavities, can be narrow enough to not damage the natural tissue fibers of the fillet. The lateral spacing between the perforations can be selected to provide a desired amount and rate of marinade introduction into the fillet.

In some methods, the poking device 30 can be applied a number of times in a cyclical process to increase the number of perforations made in the fish fillets. The poking device 30 can be pressed into the filled and lifted out of the fillet in once poking cycle. Fillets can be subjected to any number of poking cycles, such as five or ten cycles, to improve the application of the marinade into the fillets. The poking device 30 can be shifted laterally after each cycle so that the pokers 32 penetrate a different portion of the fillet in each cycle, thereby multiplying the total number of perforations and reducing the spacing between the perforations.

In some embodiments, the poking device 30 can comprise an injection device and can be configured to inject marinade through the pokers 32 and into the fish fillet. For example, the pokers 32 can include a conduit with a lower opening that is fluidly coupled to a volume of marinade contained in the upper portion of the device 30. Marinade can optionally be forced into the fish fillet using applied pressure to the marinade in order to increase the amount and rate of the marinade entering the fish fillet. In methods where the poking/injection device is applied to the fillet plural times in a cyclical pattern, marinade can be injected into the fillet during each cycle when the pokers 32 are inside the fillet.

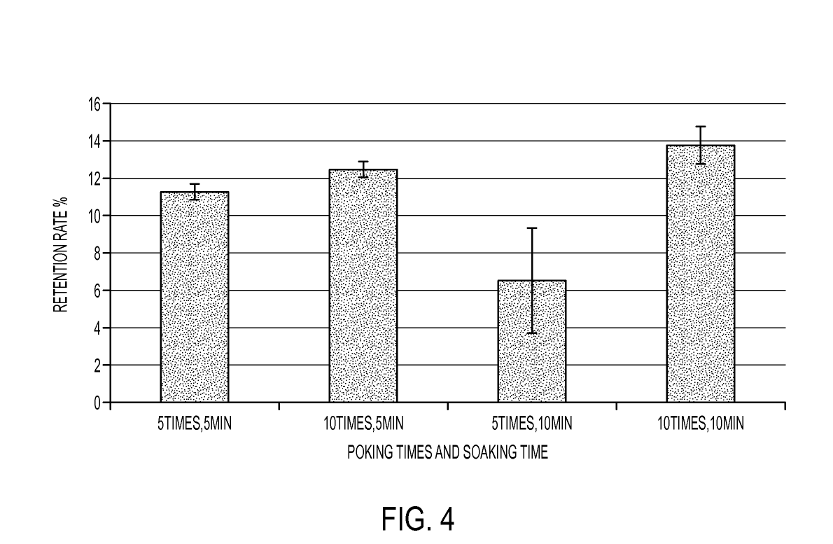

Fish fillets can optionally also be soaked in marinade to introduce marinade into the fish fillet, whether they have been previously injected or not. Soaking can be performed after poking holes in the fish fillet, such as by using the device 30, in order to increase the amount, depth, and/or rate of marinate infusion into the fish fillet. As shown in FIG. 4, the retention rate of the marinade in the fish fillet can be affected by the number of times the fillet is poked (e.g., number of poking cycles) and by the duration that the fillet is soaked in marinade. As shown, retention rates generally increase as the number of poking cycles increases and the soaking time increases.

### EXAMPLE 2

The eating quality of salmon fillets (the same can be said for other types of fish fillets), which show less moisture and reduced sensory value after long term frozen storage, can be significantly improved by preparing and injecting a salmon surimi marinade. In addition, incorporating NFB into the injection marinade can significantly enhance the nutritional quality (especially highly bioavailable calcium). This technology can be used to maintain frozen boneless fish fillets' quality similar to fresh boneless fish fillets with the added benefit of calcium enrichment from a natural, fish source. In addition, utilizing a marinade of salmon surimi and NFB, the production yield (e.g., based on drip loss and cook loss) can increase significantly.

In an exemplary testing procedure, commercial salmon surimi was first mixed with salt and tap water (300 g surimi, 25 g salt, and 1275 g water), and then NFB emulsion (32.4 mg/g) was added. The combined mixture was homogeneously blended into a marinade. Fresh salmon fillets were cut in uniform fillets of 2 inch squares. Portions with varied thickness were evenly distributed among the three treatment groups to account for differences due to fillet thickness. The fillet pieces were then individually injected with the marinade using a manual injector. Three groups, according to the injection amount, were control (no injection), <4% (less than 4% fillet weight increase from injection), and >4% (equal to or higher than 4% fillet weight increase from injection) based on the initial sample weights.

The samples were evaluated at 0 wk (before freezing), 8 wk frozen storage, and 16 wk frozen storage (−20° C.). Attributes evaluated include: drip loss (measured before cooking), cook loss, mechanical texture by wire cutter, and sensory evaluation (measured after cooking in a conventional oven set at 450F for a minimum of 12 mins). If fillets were not cooked completely within that time frame, they were subjected to additional increments of 2 mins cooking at 450F until doneness was achieved.

1) Drip Loss and Cook Loss

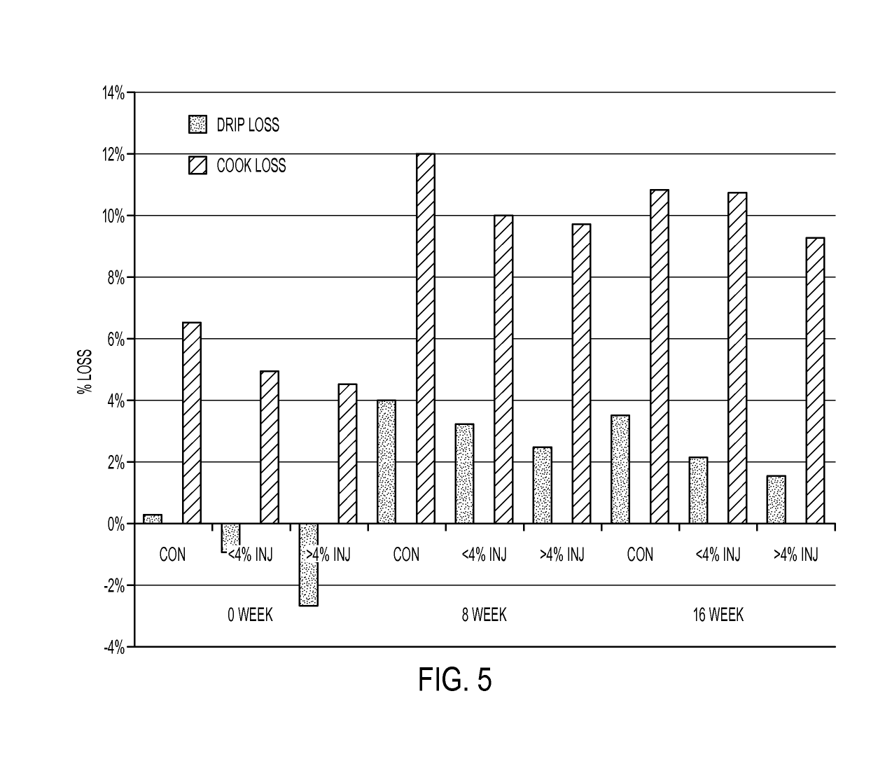

As shown in FIG. 5, drip loss, measured using uncooked salmon fillets, and cook loss, measured using cooked salmon fillets, showed similar trends. Drip loss refers to natural moisture in the fillet that forms ice crystals when frozen and then melts and drips away from the fillet when the fillet is thawed. Drip loss is reduced by adding protein (from the surimi in the marinade) into the fillet as the protein acts to retain the water in the fillet. Cook loss refers to the amount of moisture that evaporates from the fillet when it is subsequently cooked. The protein added via the marinade also helps to retain the moisture from evaporating during cooking. Extended frozen storage (8 wk and 16 wk) significantly increased the weight loss from both drip loss and cook loss. However, these losses are reduced significantly when the marinade is added to the fillet prior to freezing, especially at 4% or higher injection rate. This indicates that infusing fish fillets with the marinade made from surimi and nano fish bone effectively minimizes weight loss due to reduced drip and cook loss, which results in increased yield and profitability.

2) Texture of Salmon Fillets

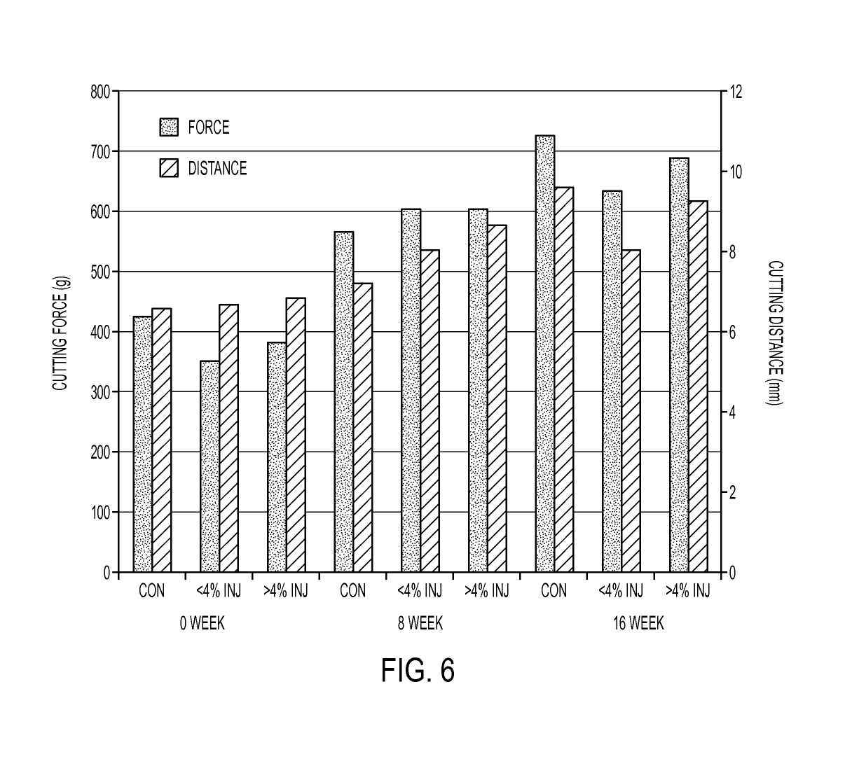

As shown in FIG. 6, as frozen storage time increases, overall texture values (cutting force and cutting distance) measured using a Warner-Bratzler shear increase gradually. Marinade-injected fillets showed slightly higher texture than the control at 8 wk. However, at 16 wk, 4% or higher injection demonstrated slightly reduced texture, indicating the injected marinade minimized texture toughening during frozen storage.

3) Sensory Evaluation

Sensory testing was conducted using a small scale group (5 members). All test samples were coded using randomly selected ID. We noted there was a significant difference between the control and treated groups. The marinated injected samples (4% or higher) were significantly favored by panelists in four different areas (moistness, texture-hardness, tackiness, and overall liking) after 16 wk frozen storage.

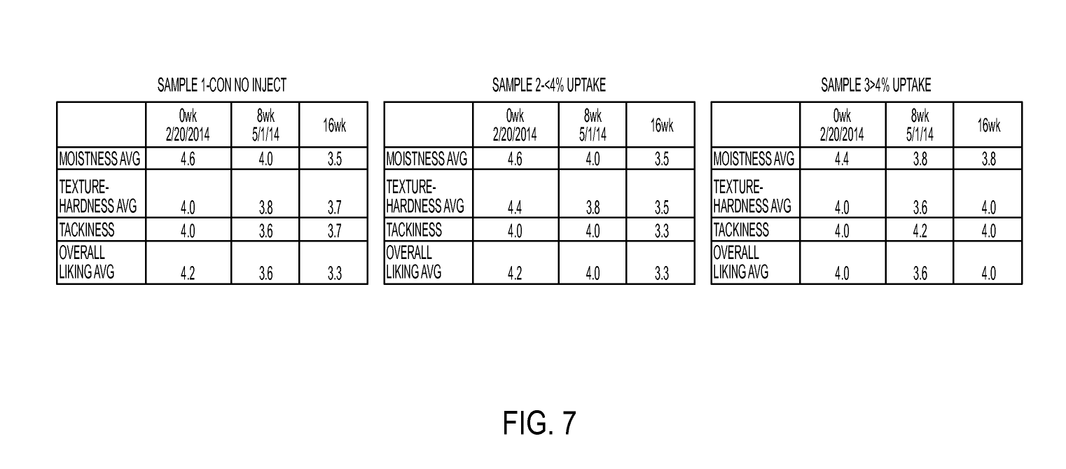

Data for samples 1, 2, and 3 are shown in FIG. 7. Sensory Evaluation used a 5 point scale (5=acceptable, 3=slightly acceptable, 1=objectionable). A score of <2.5 denotes panel thinks sample condition is questionable and no longer acceptable for purchase. As shown, sensory evaluations were generally higher for marinade-injected fillets compared to non-injected control fillets.

4) Calcium Analysis

Three salmon fillets per each treatment were ground homogeneously and shipped to a commercial analytical laboratory. The results are summarized below:

Control (No marinade injection): 0.01% (10 mg calcium/100 g meat).

<4.0% (Marinade injected less than 4%): 0.02% (20 mg calcium/100 g meat).

>4.0% (Marinade injected equal to or more than 4%): 0.03% (30 mg calcium/100 g meat).

With the addition of marinade (surimi+NFB) at higher than 4% by weight addition levels, the calcium in salmon fillet can be enriched by at least three times. Similar results would apply to other types of fish fillets.

5) Additional Features

With fine tuning of marinade formulations (which can be done with better injection needles), the level of calcium enrichment can be increased even higher while maintaining better eating quality of frozen fish fillets. In addition, the bioavailability of nano-scale calcium (which can be used instead of micro-scale calcium), can also be such that is can be readily absorbed into the human body system. This processing technology can be extended to all suitable fish, especially fin fish, to upgrade their value (e.g., sensory quality and nutritional quality and other features such as production yield). Examples include halibut, tuna, salmon, pollock, cod, tilapia, and catfish.

Using the disclosed techniques, 12-15% marinade retention rates are attainable in tilapia fillets, for example. In addition, the disclosed techniques can increase the calcium content of tilapia fillets, for example, up to approximately 0.15% (150 mg calcium in 100 g meat). Furthermore, disclosed techniques can reduce drip loss by 5-7% or more, and can reduce cook loss by 12-15% or more.

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Numbers, characteristics, materials, groups, and other features described in conjunction with a particular aspect, embodiment or example of the disclosed technology are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods.

As used herein, the terms “a”, “an”, and “at least one” encompass one or more of the specified element. That is, if two of a particular element are present, one of these elements is also present and thus “an” element is present. The terms “a plurality of” and “plural” mean two or more of the specified element. As used herein, the term “and/or” used between the last two of a list of elements means any one or more of the listed elements. For example, the phrase “A, B, and/or C” means “A”, “B,”, “C”, “A and B”, “A and C”, “B and C”, or “A, B, and C.” As used herein, the term “coupled” generally means physically coupled or linked and does not exclude the presence of intermediate elements between the coupled items absent specific contrary language.

In view of the many possible embodiments to which the principles of the disclosed technology may be applied, it should be recognized that the illustrated embodiments are only preferred examples and should not be taken as limiting the scope of the disclosure. We therefore claim as our invention all that comes within the scope of the following claims.

1. A method of enriching a fish fillet comprising:
mixing ground fish bone with surimi or a surimi slurry to form a mixture; and
adding the mixture into a fish fillet to create an enriched fish fillet.

2. The method of claim 1, wherein the ground fish bone is nano scale fish bone having an average size of less than 1 μm.

3. The method of claim 1, wherein adding the mixture into the fish fillet comprises injecting the mixture into the fish fillet.

4. The method of claim 1, wherein adding the mixture into the fish fillet comprises poking holes in the fish fillet and soaking the fish fillet in the mixture such that the mixture enters the holes in the fish fillet.

5. The method of claim 1, further comprising freezing the enriched fish fillet for later consumption.

6. The method of claim 1, wherein the ground fish bone and the surimi or surimi slurry are derived from the same fish species.

7. The method of claim 1, further comprising preparing the ground fish bone by:
reducing fish bone to microparticles having an average size of less than 500 μm; and
reducing the microparticles to nanoparticles having an average size of less than 1 μm using a wet media mill with milling beads.

8. The method of claim 1, wherein adding the mixture into the fish fillet comprises increasing the mass of the fish fillet by 4% or more.

9. The method of claim 1, wherein the surimi or surimi slurry is prepared with added NaCl to extract myofibrillar protein from the surimi.

10. The method of claim 1, wherein the added mixture increases the highly available dietary calcium of the fish fillet.

11. The method of claim 1, wherein the added mixture maintains the texture of the fish fillet after frozen storage, such that when thawed the enriched fish fillet demonstrates superior texture compared to a similarly frozen and thawed fish fillet prepared without the added mixture.

12. The method of claim 1, wherein the mixture comprises at least 50% ground fish bone.

13. An enriched fish fillet made by the method of claim 1.

14. An enriched fish fillet comprising:
a fish fillet; and
a mixture added to the fish fillet, the mixture comprising ground fish bone mixed with surimi or a surimi slurry.

15. The enriched fish fillet of claim 14, wherein the ground fish bone is nano scale fish bone having an average size of less than 1 μm.

16. The enriched fish fillet of claim 14, wherein the added mixture increases the mass of the fillet by 4% or more.

17. The enriched fish fillet of claim 14, wherein the surimi or surimi slurry includes added NaCl to extract myofibrillar protein from the surimi.

18. The enriched fish fillet of claim 14, wherein the added mixture increases the highly available dietary calcium of the fish fillet by 100% or more.

19. The enriched fish fillet of claim 14, wherein, compared to a fish fillet of the same species prepared without the added mixture, the added mixture increases moisture retention in the enriched fish fillet, reduces drip loss and cook loss when the enriched fish fillet is thawed and cooked, and demonstrates superior texture when prepared for consumption.

20. The enriched fish fillet of claim 14, wherein the mixture comprises at least 20% ground fish bone.
